(19) United States
(12) Patent Application Publication
(10) Pub. No.: US 2014/0255620 A1
(43) Pub. Date: Sep. 11, 2014

(54) SONIC GRAIN REFINEMENT OF LASER DEPOSITS

(71) Applicant: Rolls-Royce Corporation, Indianapolis, IN (US)

(72) Inventors: Quinlan Y. Shuck, Indianapolis, IN (US); Jacque S. Bader, Martinsville, IN (US)

(73) Assignee: Rolls-Royce Corporation, Indianapolis, IN (US)

(21) Appl. No.: 14/137,051

(22) Filed: Dec. 20, 2013

Related U.S. Application Data
(60) Provisional application No. 61/773,655, filed on Mar. 6, 2013.

(51) Int. Cl. B05D 3/12; B23K 10/02; B23K 9/16; B23K 26/20

(52) U.S. Cl. CPC B05D 3/12; B23K 26/20; B23K 10/02; B23K 9/16
USPC 427/560; 219/121.45; 219/121.63; 219/74; 118/620

(57) ABSTRACT

A metal additive method includes directing sonic and/or ultrasonic energy from a probe that is directed toward a melt pool during solidification of the melt pool and formation of a layer, wherein a solid portion of an object on which the pool is positioned at least partially surrounds the melt pool.

### CROSS-REFERENCE TO RELATED APPLICATIONS

This application claims priority to U.S. Provisional Patent Application No. 61/773,655 filed Mar. 6, 2013, the contents of which are hereby incorporated in their entirety.

### FIELD OF TECHNOLOGY

The purpose of the disclosure is to reduce the size and/or directionality of the grain pattern in an additive manufactured or repaired part.

### BACKGROUND

Large castings are often mechanically shaken during solidification to break up the grain structure. Magnetic stirring and beam oscillation have also been used to refine grain structure in weld deposits. Substrates have been shaken during ultrasonic or friction welding of parts. Typically, during such processes, the entire part is shaken during the welding process.

However, shaking of a large part typically includes a great amount of power. Part shaking can also create dead nodes in the part where little or no movement occurs. That is, shaking the large part may excite natural frequencies within the part that cause standing nodes (e.g., nodal vibration), which can prevent vibration from occurring throughout the part and particularly within the melt pool.

Other known methods may include magnetic stirring or beam oscillation during the melt pool solidification process. However, magnetic stirring may have detrimental effects on feedstock trajectory and/or on arc/electron beams. Beam oscillation typically includes a wider beam track than a linear weld which may not be practical on narrow parts requiring low heat input.

As such, there is a need to improve metal additive processes.

### BRIEF DESCRIPTION OF THE DRAWINGS

While the claims are not limited to a specific illustration, an appreciation of the various aspects is best gained through a discussion of various examples thereof. Referring now to the drawings, exemplary illustrations are shown in detail. Although the drawings represent the illustrations, the drawings are not necessarily to scale and certain features may be exaggerated to better illustrate and explain an innovative aspect of an example. Further, the exemplary illustrations described herein are not intended to be exhaustive or otherwise limiting or restricted to the precise form and configuration shown in the drawings and disclosed in the following detailed description. Exemplary illustrations are described in detail by referring to the drawings as follows:

FIG. 1 illustrates an object having an additive process illustrated for formation of a layer thereon.

FIG. 2 illustrates a system for forming a weld according to one embodiment.

FIG. 3 illustrates a method of forming a layer, according to an embodiment.

### DETAILED DESCRIPTION

An exemplary metal additive method includes directing sonic and/or ultrasonic energy from a probe that is directed toward a melt pool during solidification of the melt pool and formation of a layer, wherein a solid portion of an object on which the pool is positioned at least partially surrounds the melt pool.

An exemplary system includes a welder configured to form a melt pool on at least a first part, an acoustic noise probe configured to direct acoustic noise toward the melt pool during solidification of the melt pool and formation of a first layer on the first part, and a controller configured to position the noise probe proximate the melt pool and generate the acoustic noise.

An exemplary controller for controlling a welder is configured to cause the welder to cause the welder to form a weld pool on at least one part, direct an acoustic noise probe toward the weld pool during solidification of the weld pool, and position the noise probe proximate the weld pool and generate acoustic noise during formation of a first layer on the at least one part.

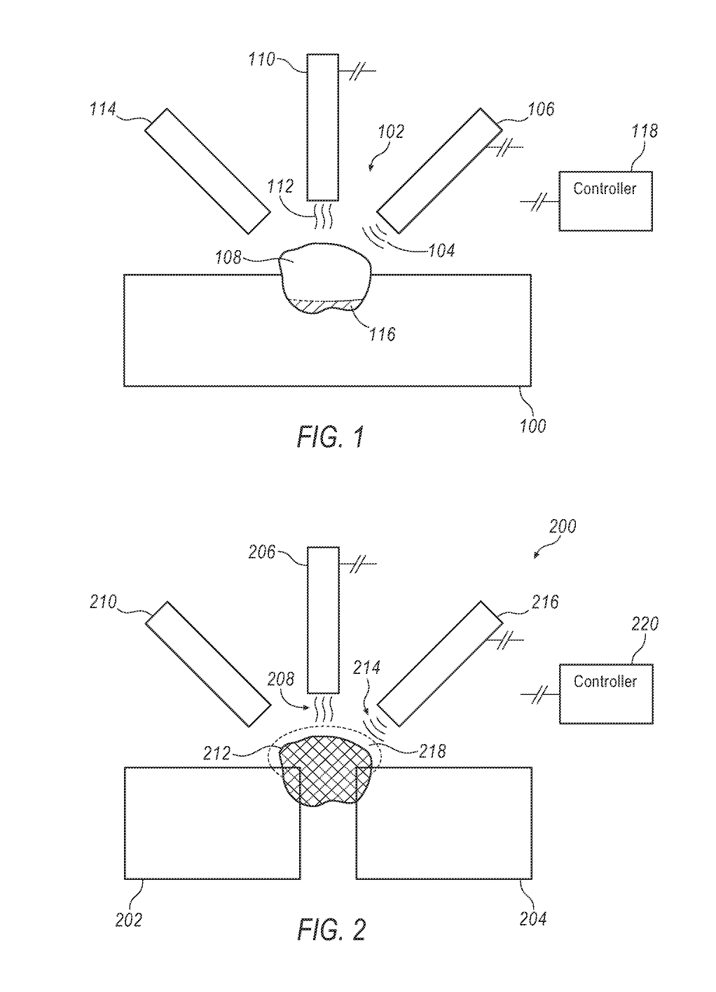

FIG. 1 illustrates an object 100 on which a layer 102 is placed, according to one embodiment. According to one embodiment, layer 102 is formed by directing sonic and/or ultrasonic energy 104 from a probe 106 toward a melt pool 108. Melt pool 108 is formed, in one example, using a welder or other device 110 that directs energy 112, such as a weld plasma, toward object 100. Sonic and/or ultrasonic energy 104 is directed toward melt pool 108 during solidification of the melt pool 108 and during formation of layer 102. Hereinafter, although it is contemplated that sonic and/or ultrasonic energy 104 is directed toward melt pool 108, energy 104 generally refers to one or both, which in one example is energy emitted as acoustic or sound energy. Layer 102, incidentally, is a solidified material formed from melt pool 108 (and thus both are illustrated. In one embodiment, melt pool 108 is formed using a weld supply material 114, which may include a wire or a ribbon material. However, it is contemplated that melt pool 108 may, in the alternative, be formed by a powder metal material, some of which is shown as element 116 that is positioned on object 100 and illustrated at a base of melt pool 108. It is understood that, although powder material 114 is shown, it is an alternative embodiment to weld supply material 114 and also will subsequently become melted and part of melt pool 108, upon additional weld energy 112 being applied thereto. Because of the position of probe 106, ultrasonic energy 104 is thereby directed only toward the melt pool 108 during solidification, and not substantially to object 100.

An area is built up by creating a melt pool and adding feedstock, such as weld supply material 114. Sonic (or ultra-sonic) energy 104 is directed at the melt pool 108 using the source or probe 106 that is positioned proximate the melt pool 108 but not in contact therewith, breaking up dendrites and refining the grain size during rapid solidification. By directing the energy 112 directly toward the melt pool 108, the melt pool 108 itself may be caused to vibrate, while avoiding vibration at nodal frequencies of object 100. Less energy may be used as well, in comparison to, for instance, devices that directly contact object 100 because the melt pool 108 is typically far smaller than the object 100 on which layer 102 is being formed. In other words, the energy 112 causes the melt pool 108 to vibrate, while object 100 generally remains unaffected. Thus, energy 112 is sufficient to merely cause vibration of the melt pool 108 and not to other parts proximate melt pool 108. The sonic, or ultrasonic, energy 104 that is directed toward the melt pool 108 is, in one embodiment, an amplified acoustic input that can include any type of input such as white noise, rock music, or any noise that can be amplified and directed toward the melt pool 108.

The nature of the sonic energy may vary depending on application, however sine waves in the audible range (20-20,000 hertz) and high sound pressure levels (above 100 dB) may cover a variety of applications. Some specialized applications may require ultrasonic (above 20,000 hertz) energy in addition to or instead of audible frequencies.

Probe 106 localizes the sonic energy to melt pool 108 by directing the energy through a tube that, in one example, is approximately ¼″ in diameter. It is contemplated that more than one probe 106, having energy either in-phase or out-of-phase, may be used to excite melt pool 108. It is also contemplated that more than one tube may originate from a single driver, or speaker. A tube (not shown) on probe 106 also may serve to isolate the driver from potential damage caused by the process such as thermal overload or localized laser reflections.

Typically, a layer, such as layer 102, that is formed using a conventional metal additive process such as direct laser deposition tends to produce highly elongated and continuous grains due to the large temperature differential between the melt pool and the substrate. As such and according to disclosed embodiments, sonic energy that includes resonant frequencies of the melt pool, breaks up the dendritic structure during solidification to help randomize grain orientation in the final layer.

Melt pool 108 is created on object 100 (or between parts to form a weld joint, in one example and as will be further illustrated) by any number of conventional fusion welding processes or combination of welding processes including laser, plasma, TIG, or MIG. Feedstock (or filler metal), in one embodiment, is added to the melt pool, building up a deposit. Feedstock may include powder, wire, or ribbon. Sonic or ultrasonic energy 104 is directed at the melt pool 108, breaking up dendrites and refining the grain size during rapid solidification.

Melt pool 108, in one embodiment, is created on a bed of powdered metal that is positioned on object 100, prior to the forming or melting process. As the melt pool traverses and locally fuses powdered metal, sonic and/or ultrasonic energy 104 is directed at the melt pool 108. Vibration of the melt pool 108 may thus be induced sonically. However, in another embodiment, vibrational energy to the melt pool is by direct contact of a mechanical or electromechanical device in close proximity of the melt pool 108.

The process may be applied in subsequent steps to subsequently apply layers on top of one another. A layer may be formed and cooled while inputting acoustic energy, and one or more subsequent layers may be applied and cooled again in the same fashion. The process can be repeated again and again, yielding an improved final structure. Thus, probe 106 and device 110 may be part of an overall welding or layer forming system that includes a controller 118 that is coupled to at least device 110 and probe 106. Controller 118 controls a position of the device 110, a position of probe 106, application of feed material 114, application of sonic energy 104 from probe 106, and a position of object 100 via a positioning table (not shown) on which object 100 is placed.

FIG. 2 illustrates a welding system 200 according to one embodiment. First and second parts 202, 204 are welded together using welding system 200. Welding system 200 includes a welder 206 that emits weld energy 208 such as a weld plasma to weld the first and second parts 202, 204 together using, in one embodiment, a weld supply material 210. A weld or melt pool 212 is formed with material from the first and second parts 202, 204, as well as the weld supply material 210. While the melt pool 212 is cooling, acoustic energy 214 is directed toward the melt pool 212 during solidification using an acoustic or sonic source 116 that does not contact the melt pool 212 or the first and second parts 202, 204.

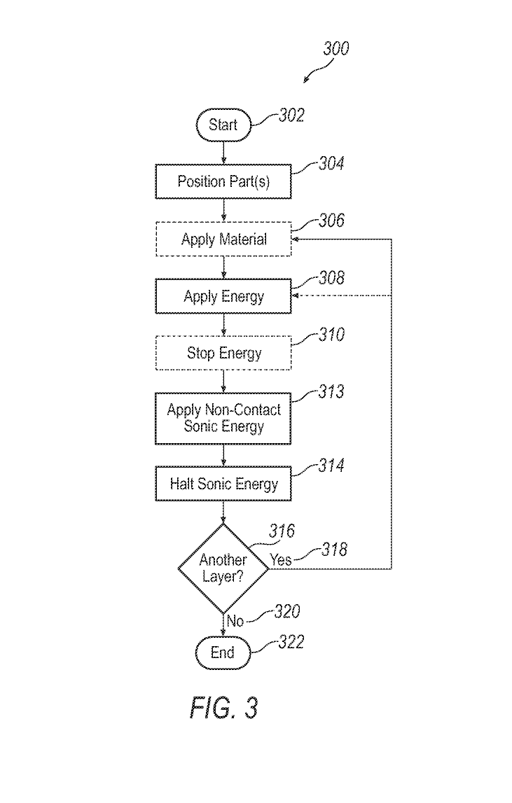

FIG. 3 illustrates a method of forming a melt pool or weld, according to an embodiment. Method 300 begins at step 302 and at step 304, the part to have a layer added to, or the parts to be welded (object 100 of FIG. 1, or parts 202 and 204 of FIG. 2), are positioned within a device for adding a layer or forming a weld. According to one optional embodiment, at step 306 a material, such as material 114 or 210, is applied during formation of the weld pool. Material 114 or 210, in one embodiment and as stated, is a powdered metal, but is not limited thereto and in other embodiments may be a wire, or a ribbon, as examples.

At step 308, energy is applied, such as energy 112 or 208, which may be laser energy or plasma energy, and may be applied using TIG or MIG welding, as examples. According to one embodiment, the applied energy may be stopped 310 prior to application of the sonic energy from the non-contact probe. However, in another embodiment, the weld energy is continually applied while the sonic energy from the non-contact probe is applied as well, at step 312. Thus, in one embodiment the weld pool is formed, the weld energy is discontinued, and the sonic energy is then applied. However, in another embodiment, the sonic energy 104, 214 is applied during application of the energy 112, 208 as well. As such, step 310 is illustrated as optional to encompass at least these two embodiments. At step 314 the sonic energy is halted and at step 316, method 300 determines (via, for instance, controller 118 or 220 that may be pre-programmed by a user) whether to apply another layer, such as layer 118. If so 318, then control returns to step 306 (or to step 308 if welding is being performed without a weld material being applied, such as when a powder 116 is used), and the process repeats. If no additional layer is applied 320, then the process ends at step 322.

It will be appreciated that the aforementioned method and devices may be modified to have some components and steps removed, or may have additional components and steps added, all of which are deemed to be within the spirit of the present disclosure. Even though the present disclosure has been described in detail with reference to specific embodiments, it will be appreciated that the various modifications and changes can be made to these embodiments without departing from the scope of the present disclosure as set forth in the claims. The specification and the drawings are to be regarded as an illustrative thought instead of merely restrictive thought.

What is claimed is:

1. A metal additive method, comprising directing one of sonic and ultrasonic energy from a probe that is directed toward a melt pool during solidification of the melt pool and formation of a layer, wherein a solid portion of an object on which the pool is positioned at least partially surrounds the melt pool.

2. The method of claim 1, wherein the probe is a non-contact probe that directs the energy, that includes resonant frequencies of the melt pool, and causes a dendritic structure of the melt pool to break up during the solidification of the layer.

3. The method of claim 1, wherein the energy is an amplified acoustic noise that is one of white noise and rock music.

4. The method of claim 1, wherein the melt pool is formed using one of a laser welder, a plasma welder, a TIG welder, and a MIG welder, and wherein the melt pool is formed using feedstock comprised of one of a powder, a wire, and a ribbon.

5. The method of claim 1, wherein the layer is formed on a single object such that the metal layer is formed on a surface of the single object.

6. The method of claim 1, wherein the layer is a weld that is formed between a first part and a second part.

7. The method of claim 1, wherein the layer is a first layer, the method further comprising forming a second melt pool with an additional feedstock on the first layer, and directing the energy from the probe toward the second melt pool and during solidification of the second melt pool, causing formation of a second layer on the first layer.

8. A system comprising:
a welder configured to form a melt pool on at least a first part;
an acoustic noise probe configured to direct acoustic noise toward the melt pool during solidification of the melt pool and formation of a first layer on the first part; and
a controller configured to position the noise probe proximate the melt pool and generate the acoustic noise.

9. The system of claim 8, wherein the acoustic noise probe is positioned as a non-contact probe and does not contact the first part or the weld pool during the solidification of the melt pool.

10. The system of claim 8, further comprising the controller configured to generate the acoustic noise as one of white noise and rock music.

11. The system of claim 8, wherein the welder is one of a laser welder, a plasma welder, a TIG welder, and a MIG welder, and wherein the welder forms the melt pool using one of a powder, a wire, and a ribbon.

12. The system of claim 8, wherein the first layer is formed only on the first part.

13. The system of claim 8, wherein the weld pool is formed using a powdered metal positioned between the two parts.

14. The system of claim 8, wherein the controller is configured to form a second melt pool as a second layer on the first layer, the second layer comprising a second melt pool formed by the welder, and the controller is configured to direct the acoustic noise from the acoustic noise probe toward the second melt pool during solidification of the second melt pool and formation of the second layer.

15. A controller for controlling a welder, the controller configured to:
cause the welder to form a weld pool on at least one part;
direct an acoustic noise probe toward the weld pool during solidification of the weld pool; and
position the noise probe proximate the weld pool and generate acoustic noise during formation of a first layer on the at least one part.

16. The controller of claim 15, wherein the controller positions the acoustic noise probe as a non-contact probe and does not contact the two parts or the weld pool during the solidification of the weld pool.

17. The controller of claim 15, further comprising the controller configured to generate the acoustic noise as one of white noise and rock music.

18. The controller of claim 15, wherein the welder is one of a laser welder, a plasma welder, a TIG welder, and a MIG welder.

19. The controller of claim 15, wherein the welder forms the weld pool using one of a powder, a wire, and a ribbon.

20. The controller of claim 15, wherein the controller is configured to form at least a second weld as a second layer on the first layer, the second layer comprising a second weld pool formed by welding and then directing the acoustic noise from the acoustic noise probe toward the second weld pool during solidification of the second weld pool.
